(19) United States
(12) Patent Application Publication
(10) Pub. No.: US 2012/0143652 A1
(43) Pub. Date: Jun. 7, 2012

(54) SALES VOLUME MONITORING

(76) Inventors: STEFAN RESAG, Walldorf (DE); Fabrice Laur, Heidelberg (DE)

(21) Appl. No.: 12/960,573

(22) Filed: Dec. 6, 2010

(51) Int. Cl. G06Q 10/00

(52) U.S. Cl. 705/7.31

(57) ABSTRACT

Various embodiments of systems and methods for sales volume monitoring are described herein. Booked sales volume for a future time period and forecasted sales volume for the future time period are received. A first value is determined for a future time period as a ratio of the booked sales volume for the future time period and the forecasted sales volume for the future time period. Booked sales volume and past sales volume for one or more past time periods that are analogous to the future time period are also received. A second value is determined from a ratio of the booked sales volume and the past sales volume for the one or more past time periods. A responsible party is notified if a ratio of the second value and the first value is out of a prescribed range.

### FIELD

The field relates generally to enterprise management applications. More particularly, the field is related to a sales monitoring application for identification of abnormal sales.

### BACKGROUND

Enterprise applications are used for several organizational operations such as, for example, sales and distribution, inventory and logistics management, planning and optimization, and materials management. One of the important advantages for any company is to achieve a shorter delivery time between date of sales order placement by a customer and date of delivery. For some businesses, the time taken to produce the product after receiving a sales order exceeds the delivery time expected by customers. In such cases, expected sales volumes are estimated by the company and materials are procured before a sales order is placed by the customer. The process of estimation is normally called demand forecasting and enterprise applications can be used for this purpose. Demand forecasting provides forecasted quantity of sales of a certain product. Based on the forecasted quantity, the production or procurement process can be started before sales orders are placed.

Since the forecasting process has to deal with several uncertainties, there is a risk of actual sales being higher or lower than forecasted quantity. If the actual sales volume is higher than the forecasted quantity, the delivery time for the additional sales orders exceeding the forecast will be much longer. The company may face the risk of losing customers and market share to competitors. If the actual sales volume is lower than the forecasted quantity, the company needs to stock excess products and materials procured to produce the products. This adds additional costs to the company and may lead to losses.

It would therefore be desirable to identify, in advance, abnormality in actual sales orders compared to forecasted sales to provide additional time for adjusting the production or procurement plans.

### SUMMARY

Various embodiments of systems and methods for sales volume monitoring are described herein. Booked sales volume for a future time period and forecasted sales volume for the future time period are received from a database. A first value is determined for a future time period as a ratio of the booked sales volume for the future time period and the forecasted sales volume for the future time period. Booked sales volume and past sales volume for one or more past time periods that are analogous to the future time period are also received from a database. The past sales volume can be a forecasted sales volume or a complete actual sales volume for a past time period. A second value is determined from a ratio of the booked sales volume and the past sales volume for the one or more past time periods. A responsible party is notified if a ratio of the second value and the first value is out of a prescribed range.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating a method for monitoring sales volume, according to one embodiment.

FIG. 2 is an illustration of sales forecast and booked sales at a current point in time, according to one embodiment.

FIG. 3 is an illustration of sales forecast and booked sales for past time periods, according to one embodiment.

FIG. 4 is a block diagram illustrating a system for monitoring sales volume, according to one embodiment.

FIG. 5 is a block diagram of an exemplary computer system according to one embodiment.

### DETAILED DESCRIPTION

Embodiments of techniques for sales volume monitoring are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

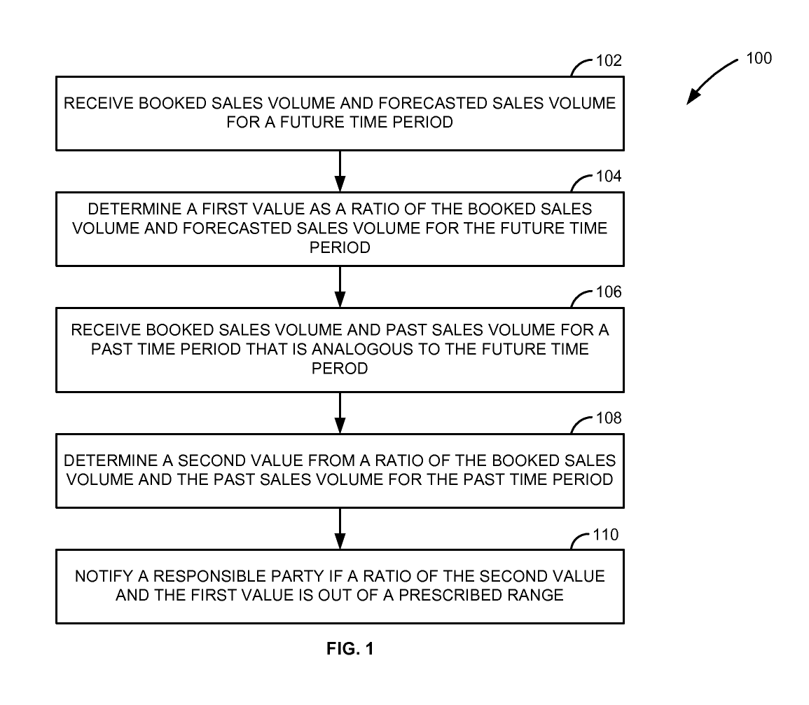

FIG. 1 illustrates an embodiment of a method for monitoring sales volume 100. Demand forecasting is an important activity for any business. Quantities of sales expected for a certain period of time in future are estimated using demand forecasting techniques. Businesses prepare to meet the forecasted sales by procuring materials and other resources. For a time period in future, a forecasted sales volume can be calculated by aggregating the forecasted sales within that time period. Enterprise systems can be used for such forecasting purposes. Data of forecasted sales is stored in a database associated with the enterprise system. The database of the enterprise system also stores data of existing or booked sales orders placed by customers, booked sales volumes from past time periods, and forecasts for the past time periods.

At 102, booked sales volume and forecasted sales volume for a future time period are received from the database. Booked sales volume for the future time period can be determined from the existing sales orders at a current point in time. The current point in time can be a point in time when the method 100 is performed (e.g. Feb. 1, 2011). In one embodiment, existing sales orders with delivery dates in the future time period are aggregated to determine the booked sales volume. The forecasted sales volume for the future time period is the sum of forecasted sales for the future time period. The future time period for the method 100 is selected so that a company has sufficient time to adjust production or resource procurement plans. Considering any events in the future time period, a company should be able to react to external factors and accordingly alter production or procurement plans to avoid losses or loosing potential sales.

At 104, a first value is determined for a future time period using booked sales volume and forecasted sales volume for the future time period. The first value can be referred as actual percentage ratio (APR), in one embodiment. The first value is calculated as the ratio of the booked sales volume and the forecasted sales volume. For example, if the future time period is the entire month of March 2011:

First value=booked sales volume in March 2011/forecasted sales volume in March 2011

At 106, booked sales volume and past sales volume for a past time period are received from the database. The past time period is analogous to the future time period selected in 102. For example, by analogous it is meant, if the future time period is March 2011, the past time period is March 2010. As another example, if the future time period is third quarter of 2011, the past time period is third quarter of 2010. The booked sales volume for the past time period can be determined from the sales orders that are booked until a historical point in time that is analogous to the current point in time. For example, if the current point in time is Feb. 1, 2011, the historical point in time is of Feb. 1, 2010. The sales orders for March 2010 that are booked until the Feb. 1, 2010 are aggregated to determine the booked sales volume for March 2010.

In one embodiment, the past sales volume for the past time period is a forecasted sales volume for the past time period. The forecasted sales volume for the past time period is the sum of forecasted sales for the past time period. In another embodiment, the past sales volume for the past time period is a complete sales volume for the past time period. The complete sales volume for the past time period is the sum of actual sales for the past time period. In the following description, only the forecast sales volume for the past time period is mentioned for calculating a second value. However, it should be noted that the complete sales volume is also equally applicable instead of the forecasted sales volume to calculate the second value.

At 108, a second value is determined using booked sales volume and forecasted sales volume for at least one past time period. For example, a ratio of the booked sales volume for that past period (e.g. March 2010) and the forecasted sales volume for the same past period (March 2010) is determined. In one embodiment, the second value can be referred as Expected Percentage Ratio (EPR).

In another embodiment, the second value is determined using the booked sales volumes and the forecasted sales volumes for a plurality of past time periods. All the past periods are analogous to the future time period. If the future time period is the March 2011, the past time periods include March 2010, March 2009, and March 2008. Also, as described previously, booked sales volume for a past time period is determined from the sales booked until a historical point in time that is analogous to the current point in time. If the current point in time is Feb. 1, 2011, the historical points in time include Feb. 1, 2010, Feb. 1, 2009, and Feb. 1, 2008. The ratio of booked sales volume and the forecasted sales volume for each of these past time periods are determined. The second value is then determined as an average of these ratios. For example:

Ratio 1=booked sales volume for March 2010/forecasted sales volume in March 2010

Ratio 2=booked sales volume for March 2009/forecasted sales volume in March 2009

Ratio 3=booked sales volume for March 2008/forecasted sales volume in March 2008

Second value=(Ratio 1+Ratio 2+Ratio 3)/3

At 110, a ratio of the second value to the first value (EPR/APR) is calculated. If this ratio is out of a prescribed range, then a responsible party is notified about abnormality in sales. The responsible party can then adjust production and procurement plans. The ratio of the second value to the first value represents deviation of sales volume in the future time period in relation to historical sales volume for the past time periods that are analogous to the future time period, while considering the forecasted volumes for the future and past time periods. If the ratio (EPR/APR) is less than ‘1,’ then it indicates that sales volume for the future time period is more than expected. If the ratio (EPR/APR) is more than ‘1,’ then it indicates that sales volume for the future time period is less than expected.

The prescribed range of the ratio corresponds to deviation between booked sales with respect to forecasted sales of the future time period and booked sales with respect to forecasted sales of analogous past time periods. This deviation will be represented by the ratio (EPR/APR). Some deviation is generally acceptable for any business or a company. In one embodiment, a user can define the prescribed range. In another embodiment, the prescribed range can be defined as part of system configuration. For example, the prescribed range can be from ‘0.8’ to ‘1.2’. If the ratio (EPR/APR) is outside of this prescribed range, then it is an indication of abnormality in sales. A notification can then be sent to a responsible party about abnormal sales. The responsible party can then take a suitable action.

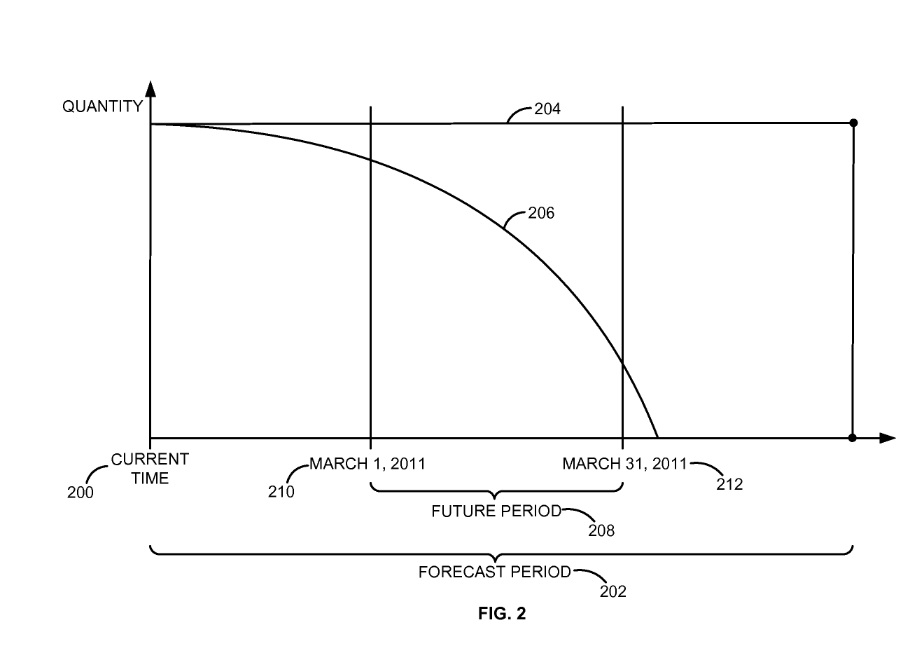

Referring to FIG. 2, the method for monitoring sales volume is performed at a current point in time 200. Sales forecast is made for a forecast period 202. In this example, the forecasted sales 204 are assumed to be constant throughout the forecast period 202. The booked sales 206 for the forecast period are determined from the existing sales orders placed by customers. In one embodiment, the delivery dates of the sales orders are used to determine the booked sales 206. For example, booked sales for the forecast period are determined as the sales orders that have delivery dates in the forecast period.

The period of interest for the sales volume monitoring method is the future time period 208 defined by two future points in time 210 and 212 within the forecast period 202. As an example, the future period 208 is defined as the period from Mar. 1, 2011 to Mar. 31, 2011. The forecasted sales volume for the future time period 208 is the sum of forecasted sales 204 in the future period 208. The booked sales volume for the future time period 208 is the sum of booked sales 206 in the future period 208.

As cited previously, the future time period 208 is selected so that a company has sufficient time to adjust production or resource procurement plans. A user is provided with the flexibility of defining the future time period 208. In another embodiment, the future time period 208 is selected based on the concepts of a planning time fence and a demand time fence. The future time period 208 can be selected as a period between the planning time fence and the demand time fence. The planning time fence can be Mar. 31, 2010 and the demand time fence can be Mar. 1, 2010.

A planning time fence is defined as a point in time in the future within a planning horizon before which planning proposals are considered as stable. The planning time fence marks a boundary inside of which changes to a schedule may adversely affect component schedules, capacity plans, customer deliveries, and cost. Outside the planning time fence, customer orders may be booked and changes to a master schedule can be made within the constraints of a production plan. A master schedule is an operational plan that can include time periods, forecasts, customer orders, available-to-promise quantities, and a master production schedule.

Demand time fence is a point in time in future before which the forecast is no longer included in total demand and projected available inventory calculations. Only customer orders are considered inside the demand time fence. Beyond the demand time fence, total demand can be a combination of actual orders and forecasts. In some contexts, the demand time fence may correspond to a point in the future inside which changes to a master schedule must be approved by an authority higher than the master scheduler. However, customer orders may still be promised inside the demand time fence without approval from higher authority if there are quantities that are available-to-promise (ATP).

The period between the current time and Mar. 1, 2011 can be called as a frozen period where production is mainly driven by existing sales orders. The period after Mar. 31, 2011 and until the end of the forecast period 202 can be called as a liquid period where production is mainly driven by sales forecast. There may be only few sales orders with a delivery date in the liquid period. The future period 208 used for the sales volume monitoring method can be referred to as slushy period or trading period where significant sales order volumes can exist and a company still has the time to react to the production and procurement plans.

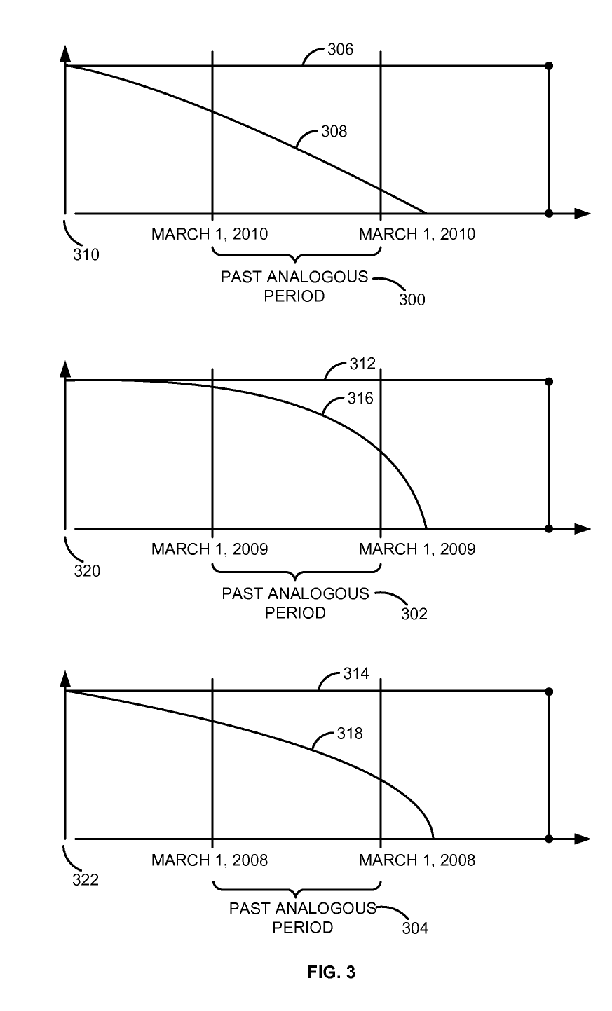

FIG. 3 is an exemplary illustration of sales forecast and booked sales for a plurality of past time periods 300, 302, and 304. These past time periods 300, 302, and 304 are analogous to the future time period (208, as shown in FIG. 2). The forecasted sales volume for the past time period 300 in 2010 is the sum of forecasted sales 306 in the period from Mar. 1, 2010 to Mar. 31, 2010. The booked sales volume for the future time period is the sum of booked sales 308 for Mar. 1, 2010 to Mar. 31, 2010 until a historical point in time 310 that is analogous to the current point in time (200 in FIG. 2). A ratio of the booked sales volume and the forecasted sales volume for the period from Mar. 1, 2010 to Mar. 31, 2010 can then be determined. Similarly, ratios of forecasted sales volumes and the booked sales volumes for past time periods 302 and 304 in 2009 and 2008 are calculated using forecasted sales 312, 314 and booked sales 316, 318 until historical points in time 320, 322, respectively. The second value (EPR) is then determined as an average of these ratios.

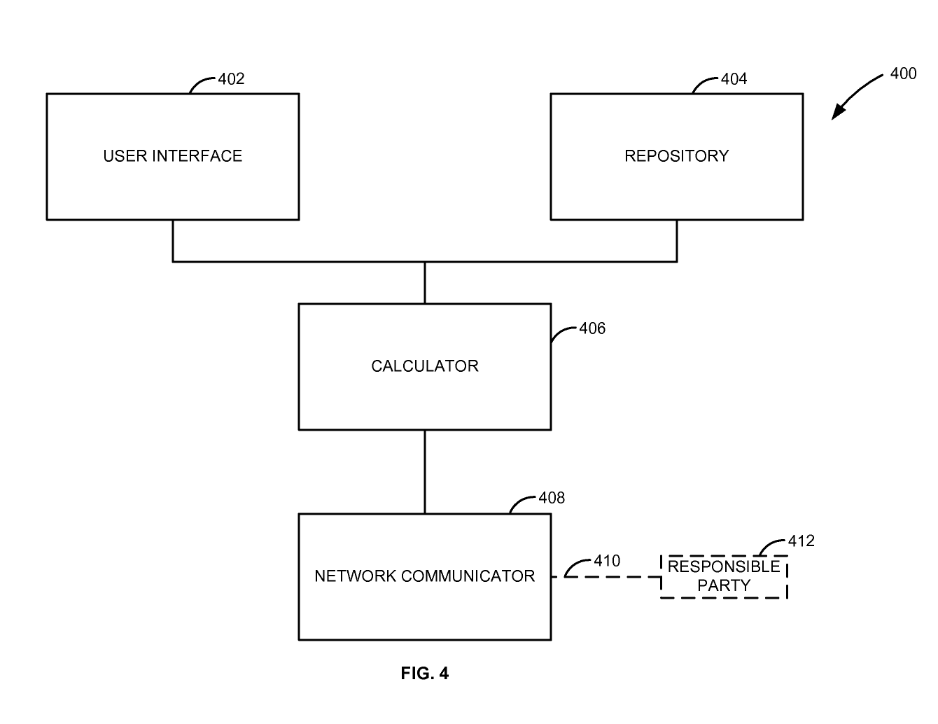

FIG. 4 is a block diagram illustrating an embodiment of a system 400 for monitoring sales volume. The system 400 can be part of or integrated with an Enterprise system such as an Enterprise Resource Planning (ERP) system or a module of an ERP system where master scheduling and other planning operations can be performed. In one embodiment, the system can be part of alerting system of an ERP system, e.g. SAP® BUSINESS BY DESIGN Supply Chain Planning & Control. Production or operational planning proposals can be created using an enterprise system. Once created, planning proposals may not be changed inside a planning time fence. Changes inside the planning time fence can be made manually by a planner. Planning proposals can be changed or created outside the planning time fence.

A user interface 402 is provided to define the future time period (slushy period). An authorized user can define the future time period. In one embodiment, the authorized user can also define a prescribed range for the ratio of the second value to the first value via the user interface. The number of past analogous time periods to be considered for determining the EPR/APR ratio can be part of the system configuration or can be user definable. Also, a flexibility to select a forecasted sales volume or a complete sales volume for calculating the second value can be provided. If the system 400 is integrated or part of an enterprise system, the above UI functionalities can be provided within a user interface of an enterprise application.

The repository 404 can be a database or a data warehouse where data of booked sales, actual sales, and forecasted sales for the forecast period and all past time periods is stored. This data is used by a calculator 406 to calculate booked sales volumes and forecasted sales volumes for the future time period and past time periods that are analogous to the future time period. The calculator 406 further calculates the first value (APR), the second value (EPR), and the ratio (EPR/APR) of the second value to the first value. If the ratio is out of a prescribed range, a network communicator 408 sends a notification 410 to a responsible party 412 about the abnormality in sales volume in the future time period. The notification 410 can be sent via electronic communication such as email or mobile communication such as SMS. The notification 410 can include a message about abnormality in the booked sales volume in the future time period, necessitating a suitable action on planning side.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

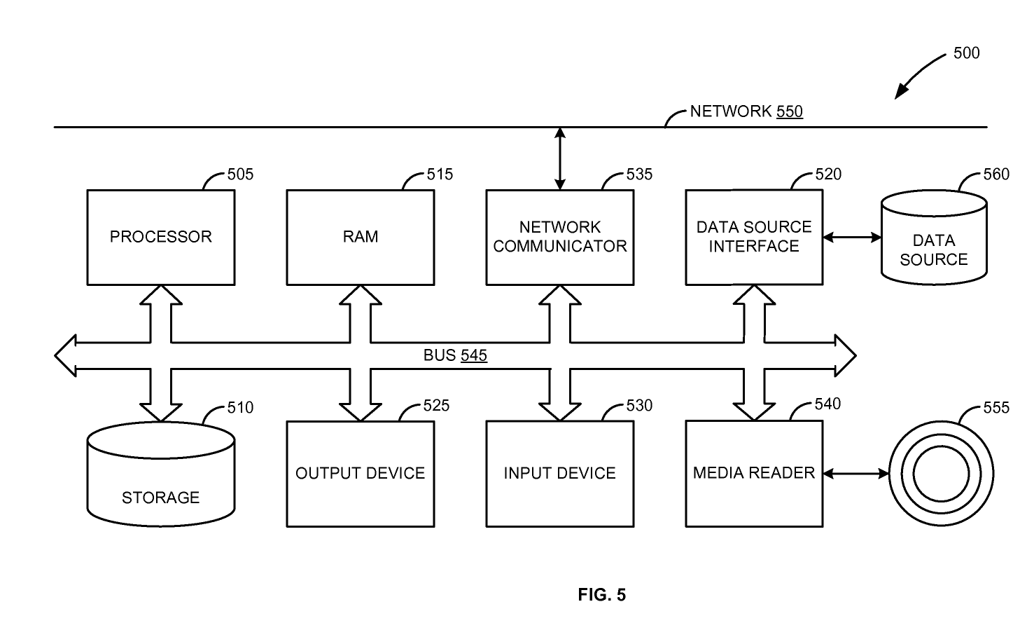

FIG. 5 is a block diagram of an exemplary computer system 500. The computer system 500 includes a processor 505 that executes software instructions or code stored on a computer readable storage medium 555 to perform the above-illustrated methods of the invention. The computer system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. The stored instructions may be further compiled to generate other representations of the instructions and dynamically stored in the RAM 515. The processor 505 reads instructions from the RAM 515 and performs actions as instructed. According to one embodiment of the invention, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Each of these output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 520 to access data source 560. The data source 560 can be accessed via one or more abstraction layers implemented in hardware or software. For example, the data source 560 may be accessed by network 550. In some embodiments the data source 560 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
receive booked sales volume for a future time period and forecasted sales volume for the future time period;
determine a first value as a ratio of the booked sales volume for the future time period and the forecasted sales volume for the future time period;
receive booked sales volume and a past sales volume for one or more past time periods that are analogous to the future time period;
determine a second value from a ratio of the booked sales volume and the past sales volume for the one or more past time periods; and
notify a responsible party if a ratio of the second value and the first value is out of a prescribed range.

2. The article of manufacture of claim 1, wherein the instructions to determine the second value, comprise instructions to:
determine the second value as an average of ratios of the booked sales volume and the past sales volume for a plurality of past time periods, wherein each of the plurality of past time periods is analogous to the future time period.

3. The article of manufacture of claim 1, wherein the instructions to notify a responsible party, comprises instructions to:
notify the responsible party through at least one of electronic communication and mobile communication.

4. The article of manufacture of claim 1, wherein the future time period is a time period between a planning time fence and a demand time fence.

5. The article of manufacture of claim 1, wherein the future time period is within a forecast period.

6. The article of manufacture of claim 1, wherein the booked sales volume for the future time period is based on existing sales orders at a current point in time and the booked sales volume for the past time periods is based on sales orders at a historical point in time that is analogous to the current point in time.

7. The article of manufacture of claim 1, wherein the past sales volume comprises a forecasted sales volume for one or more past time periods or a complete sales volume for one or more past time periods.

8. The article of manufacture of claim 1, further comprising instructions which when executed by the computer further causes the computer to:
enable a user to define the future time period and the prescribed range.

9. A computerized method for monitoring sales volume, the method comprising:
receiving booked sales volume for a future time period and forecasted sales volume for the future time period;
determining a first value as a ratio of the booked sales volume for the future time period and the forecasted sales volume for the future time period;
receiving booked sales volume and a past sales volume for one or more past time periods that are analogous to the future time period;
determining a second value from a ratio of the booked sales volume and the past sales volume for the one or more past time periods; and
notifying a responsible party if a ratio of the second value and the first value is out of a prescribed range.

10. The method of claim 9, wherein determining the second value, comprising:
determining the second value as an average of ratios of the booked sales volume and the past sales volume for a plurality of past time periods, wherein each of the plurality of past time periods is analogous to the future time period.

11. The method of claim 9, wherein provide the notification to the responsible party, comprising:
notify the responsible party through at least one of electronic communication and mobile communication

12. The method of claim 9, wherein the future time period is a time period between a planning time fence and a demand time fence.

13. The method of claim 9, wherein the future time period is within a forecast period.

14. The method of claim 9, wherein the booked sales volume for the future time period is based on existing sales orders at a current point in time and the booked sales volume for the past time periods is based on sales orders at a historical point in time that is analogous to the current point in time.

15. The method of claim 9, wherein the past sales volume comprises a forecasted sales volume for the one or more past time periods or a complete sales volume for the one or more past time periods.

16. The method of claim 9, further comprising:
enabling a user to define the future time period and the prescribed range.

17. A computer system for monitoring sales volume, comprising:
a computer memory to store program code; and
a processor to execute the program code to:
receive booked sales volume for a future time period and forecasted sales volume for the future time period;
determine a first value as a ratio of the booked sales volume for the future time period and the forecasted sales volume for the future time period;
receive booked sales volume and a past sales volume for one or more past time periods that are analogous to the future time period;
determine a second value from a ratio of the booked sales volume and the past sales volume for the one or more past time periods; and
notify a responsible party if a ratio of the second value and the first value is out of a prescribed range.

18. The system of claim 17, wherein the program code to determine the second value, comprise program code to:
determine the second value as an average of ratios of the booked sales volume and the past sales volume for a plurality of past time periods, wherein each of the plurality of past time periods is analogous to the future time period.

19. The system of claim 17, wherein the program code to provide the notification to the responsible party, comprise program code to:
notify the responsible party through at least one of electronic communication and mobile communication.

20. The system of claim 17, wherein the future time period is a time period between a planning time fence and a demand time fence.

21. The system of claim 17, wherein the future time period is within a forecast period.

22. The system of claim 17, wherein the booked sales volume for the future time period is based on existing sales orders at a current point in time and the booked sales volume for the past time periods is based on sales orders at a historical point in time that is analogous to the current point in time.

23. The system of claim 17, wherein the past sales volume comprises a forecasted sales volume for the one or more past time periods or a complete sales volume for the one or more past time periods

24. The system of claim 17, wherein the processor further executes the program code to:
enable a user to define the future time period and the prescribed range.
